(19) United States
(12) Patent Application Publication
(10) Pub. No.: US 2025/0392654 A1
(43) Pub. Date: Dec. 25, 2025

(54) Identifiable Connectable Packets

(71) Applicant: TEXAS INSTRUMENTS INCORPORATED, Dallas, TX (US)

(72) Inventors: Yaron Alpert, Hod-Hasharon (IL); Maxim Altshul, Kadima (IL); Inbal Farchy, Beer-Sheva (IL); Barak Cherches, Ramat-Hakovesh (IL)

(21) Appl. No.: 18/785,561

(22) Filed: Jul. 26, 2024

Related U.S. Application Data
(60) Provisional application No. 63/662,171, filed on Jun. 20, 2024.

(51) Int. Cl. H04L 69/22; H04L 1/00; H04W 76/14

(52) U.S. Cl. CPC H04L 69/22; H04L 1/0006; H04W 76/14

(57) ABSTRACT

A method may include a wireless device including its address in a transmitted packet. The transmitted packet may be of a type that is associated with a connectable event. A scanning device may receive the transmitted packet, decode the transmitted packet, and access the various data in the transmitted packet. The scanning device may access the address of the wireless device and determine whether the address of the wireless device corresponds to an address of a desired device. The scanning device may then either ignore the transmitted packet or move forward with other actions, such as monitoring for an auxiliary packet associated with the transmitted packet or establishing a connection with the wireless device.

### CROSS-REFERENCE TO RELATED APPLICATIONS

The present application claims priority to U.S. Provisional Patent Application 63/662,171, filed Jun. 20, 2024, the disclosure of which is hereby incorporated by reference in its entirety.

### TECHNICAL FIELD

The present disclosure relates generally to electronic systems and methods, and, particular embodiments, to connectable packets having device identifiers.

### BACKGROUND

Bluetooth (BT) Classic and Bluetooth Low Energy (BLE) are examples of communication protocol standards that facilitate wireless data transmission over a radio link. Various applications include a BLE master or central device (a “central”) that maintains wireless communication links with multiple BLE slave or peripheral devices (each a “peripheral”).

During wireless communication, a BLE device may perform the functions of an advertiser by transmitting advertising packets. Another device, performing the functions of a scanner, may receive the advertising packets. The scanner may parse an advertising packet for a pointer to a data channel and a time for an auxiliary packet. The scanner may then tune to the particular data channel at the time to receive and parse the auxiliary packet. The scanner may or may not establish a connection with the advertiser after having examined the data in the auxiliary packet. Currently, advertising packets that advertise a connectable event do not include device address data for the advertiser.

### SUMMARY

In accordance to an embodiment, a method includes: transmitting, by a first device in a first communication channel, a first packet indicative of timing of a second packet to be transmitted in a second communication channel, the first packet including a first address associated with the first device, where the first packet is of a first type, and where the second packet is of a second type, where the first packet has a protocol data unit (PDU) field including a header and a payload, where the payload includes data indicative of the timing of the second packet and of the second communication channel and further includes the first address, and further where the payload includes an Extended Header Length field indicating a length of an Extended Header field, where the payload includes an address field between the Extended Header Length field and the Extended Header field, and where the address field includes the first address; and establishing a connection between the first device and a second device based on receiving, by the first device, a third packet from the second device, where the third packet is responsive to the second packet.

In accordance to an embodiment, an electronic device includes: a transceiver; and a processor configured to: receive a first packet from an advertising device via the transceiver in an advertisement channel; decode the first packet and parse data of the first packet, where the first packet includes an advertising packet for connection, where the first packet includes first data indicating a data channel for a second packet and timing of the second packet, and second data indicating a source address of the advertising device; parse, within a protocol data unit (PDU) field of the first packet, a header and a payload, where the payload includes the first data and the second data; parse, from the payload, an Extended Header Length field indicating a length of an Extended Header field, further where the payload includes an address field between the Extended Header Length field and the Extended Header field, where the address field includes the second data; and determine whether to monitor the data channel to receive the second packet in response to parsing the second data.

In accordance to an embodiment, an electronic device includes: a transceiver; and a processor configured to: receive a first packet over the air via the transceiver from an advertising device; decode the first packet and parse data of the first packet, where the first packet includes an advertising packet for connection, where the first packet includes data indicating a data channel location of a second packet and a time of the second packet and data indicating a source address of the advertising device; parse, within the first packet, a header and a payload, where the payload includes the data indicating the data channel location and the data indicating the source address of the advertising device; parse, from the payload: an Extended Header field, an Extended Header Length field indicating a length of the Extended Header field, and an address field having the address information of the advertising device; and determine not to receive the second data packet based on the source address.

In accordance to an embodiment, an electronic device includes: a transceiver; and a processor configured to: receive a first packet over the air via the transceiver from an advertising device; decode the first packet and parse data of the first packet, where the first packet includes an advertising packet for connection, where the first packet includes data indicating a data channel location of a second packet and a time of the second packet and data indicating a source address of the advertising device; parse, within the first packet, a header and a payload, where the payload includes the data indicating the data channel location and the data indicating the source address of the advertising device; parse, from the payload: an Extended Header field, an Extended Header Length field indicating a length of the Extended Header field, and an address field having the address information of the advertising device; and not monitoring the data channel during the time of the second packet based on the source address.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of two example wireless communication devices, which may perform multi-packet acknowledgment, according to various embodiments;

FIG. 2 is an illustration of an example time domain operation 200, according to various embodiments;

FIG. 3 is an illustration of an example table 300, according to various embodiments, for an extended advertising scheme;

FIG. 4 is an illustration of an example protocol data unit (PDU) of a link layer packet, such as an extended advertising packet, according to various embodiments;

FIG. 5 is an illustration of an example Table of PDU types, according to various embodiments;

FIG. 6 is an illustration of an example time domain operation, according to various embodiments;

FIG. 7 is an illustration of an example payload having device identifying data, according to various embodiments;

FIG. 8 is an illustration of an example packet, according to various embodiments;

FIG. 9 is an illustration of an example method for providing advertising device address data in an extended advertising packet, according to various embodiments;

FIG. 10 is an illustration of an example method for receiving and acting upon an extended advertising packet having advertising device address data, according to various embodiments; and

FIG. 11 is an illustration of an example method for receiving and acting upon an extended advertising packet having advertising device address data, according to various embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Embodiments of the present disclosure are described in specific contexts, e.g., an advertising packet having advertising device identifying data in Bluetooth Low Energy (BLE) communications. Some embodiments may be used in other communication protocols, such as other proprietary or standard-based wireless protocols. Some embodiments may be used in wired communication protocols, such as power line communication (PLC) protocols, wired networking protocols, or other serial or parallel wired communication protocols.

In an embodiment, a device is configured to act as an advertising device. The advertising device may transmit advertising packets on one or more primary advertising channels. Examples of primary advertising channels include channels 37, 38, 39 in the BLE standard. The advertising packets may include data indicating a channel index on which an auxiliary packet is sent, a time offset for the auxiliary packet, and a physical (PHY) layer for use with the auxiliary packet. Accordingly, the device may further be configured to transmit auxiliary packets on a data channel according to the channel index and at a timing according to the time offset. In BLE, the advertising and auxiliary packets may include layer 2 packets transmitted over the air. Furthermore, the advertising packets may correspond to the extended advertising packets of having a protocol data unit (PDU) of type ADV_EXT_IND, and the auxiliary packets may correspond to auxiliary packets having a PDU of type AUX_ADV_IND in BLE.

Further in this example, the advertising packet may include information indicating a connectable advertising mode. Examples of connectable advertising modes include connectable undirected and connectable directed. A connectable undirected advertising event may result in a connection request from any scanning device. By contrast, a connectable directed advertising event may result in a connection request only from a device identified by a target address in the advertising packet.

Continuing with the example, the advertising packet may also include an address of the device. An example of an address may include a public address, such as a Bluetooth Device (BD) address or other appropriate address. A scanning device, which may receive the advertising packet, may parse the packet to read the data in the packet. The scanning device may then determine to either monitor the channel index to receive the auxiliary packet or to simply ignore the advertisement. Should the scanning device determine to monitor the channel index, then the scanning device may further receive and decode the auxiliary packet, transmit a connection request to the advertising device, and establish a connection with the advertising device.

By contrast, in the current BLE standard, advertising packets transmitted according to a connectable advertising mode do not include an address of the advertiser. Therefore, from the perspective of a scanning device, the connectable advertising packet appears as an anonymous advertiser.

Receiving anonymous advertising packets may be acceptable in some scenarios. However, anonymous advertising packets may result in inefficiencies in other scenarios. For instance, a crowded advertising scenario may include many BLE advertisers transmitting advertising packets without regard to collisions. A scanning device may be configured to look for a particular advertising device and to establish a connection with that particular advertising device. The scanning device may receive an advertising packet having no advertising device address. The scanning device may then monitor a second channel, as indicated in the advertising packet, to receive the auxiliary packet. Once the scanning device has received and parsed the auxiliary packet, then the scanning device may determine whether the advertising device corresponds to the desired device. In a crowded advertising scenario, the chance that the advertising device is not the desired device may be relatively high. As a result, the scanning device may receive further advertising packets and repeat the process until it can make a connection to the desired device.

Repeated attempts to connect to a desired device by decoding advertising packets and auxiliary packets may be wasteful of time and battery power. By contrast, various embodiments may include advertising device address information in the advertising packet, thereby allowing the scanning device to determine whether the advertising device is the desired device without having to decode an auxiliary packet.

Furthermore, in the current BLE standard, some crowded advertising scenarios may cause a connection between the scanning device and a desired device to be delayed. In one example, an advertising device may transmit an anonymous advertising packet, which is received and decoded by the scanning device, and a scanning device may then monitor the data channel indicated in the advertising packet. However, it may be possible that the auxiliary packet overlaps in the time domain with an advertising packet transmitted by the desired device. As a result, the scanning device may miss the advertising packet on a primary advertising channel from the desired device as it is monitoring the data channel for the auxiliary packet from the other advertising device. Missing the advertising packet, especially if it occurs repeatedly, may cause undesirable delay in establishing a connection.

By contrast, various embodiments may include advertising device address information in the advertising packet, as noted above. The scanning device may then receive and decode the advertising packet, read the device address data, and determine whether or not to monitor the data channel for the auxiliary packet. In an instance in which the device address information in the advertising packet is different from an expected address of the desired device, the scanning device may determine to continue monitoring the primary advertising channels and not monitor the data channel for the auxiliary packet. As a result, the scanning device may, in some circumstances, establish a connection with the desired device more quickly.

Various implementations may find use in automotive applications, sensor applications, and the like. In fact, the scope of implementations is not limited to any particular application. Nevertheless, in an automotive application, a scanning device may include a smart phone, and an advertising device may include one or more BLE devices in an automobile. The delay caused by timing overlap of the auxiliary packet and the advertising packet of the desired device may cause user dissatisfaction. Various embodiments may reduce or eliminate that delay and thereby increase user satisfaction.

Various implementations may increase a size of an advertising packet to include the advertising device data, compared to the current BLE standard. Increasing the size of the advertising packet may be expected to result in incrementally more collisions in a crowded advertising scenario. However, it is expected that the increase in collisions would be relatively small because the additional address data may be less than 1% of the size of the advertising packet. Furthermore, it is expected that any increase in collisions would be more than made up for by the decrease in time to connect and a decrease in power used to scan by allowing a scanning device to ignore advertisements based on advertising data.

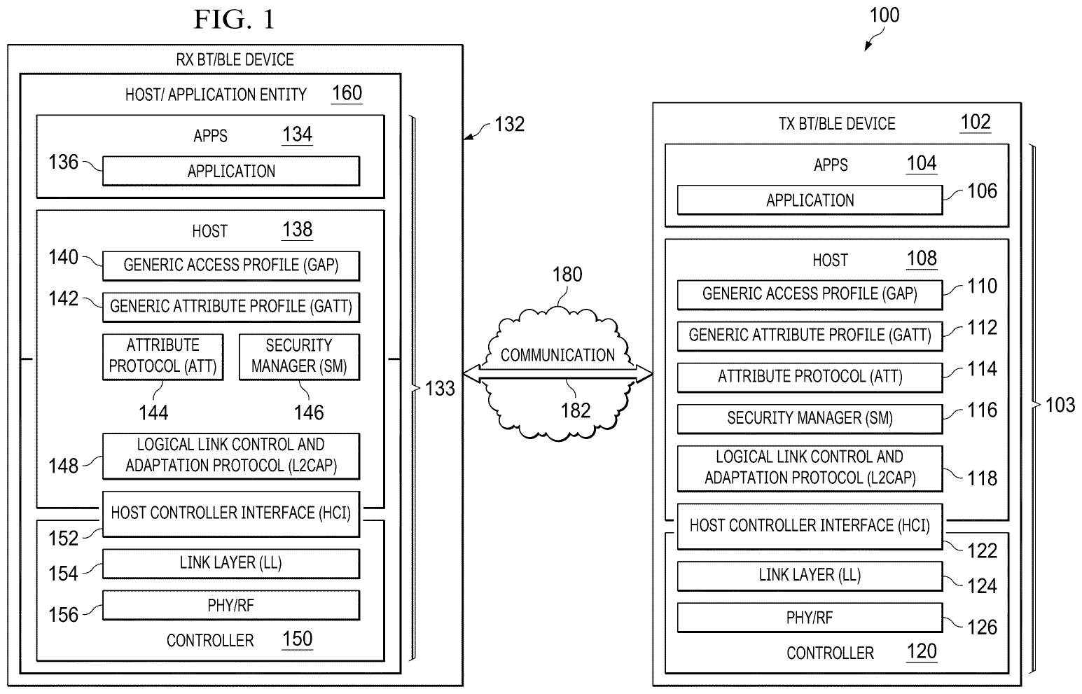

FIG. 1 is an illustration of an example first Bluetooth (BT) or Bluetooth Low Energy (BLE) device 132 and a second BT/BLE device 102, according to various embodiments. For instance, example devices 132 and 102 may include functionality in their link layers 154, 124 to include device identifying data in connectable advertising packets (when functioning as an advertiser) and to determine whether to monitor a data channel for an auxiliary packet in response to the device identifying data (when functioning as a scanner). In one example, device 102 may be physically implemented as circuits on a first semiconductor device, and device 132 may similarly be physically implemented as circuits on a second semiconductor device. Each of the devices 102, 132 may be included in separate semiconductor packages as appropriate.

In the present example, both devices 132 and 102 are capable of transmitting and receiving. The BT/BLE device 132 (e.g., a key fob, a wearable device, a smartphone, a sensor, an in-vehicle component, or other device with BT/BLE functionality) is in communication with the BT/BLE device 102 (e.g., another key fob, a wearable device, a smartphone, a sensor, an in-vehicle component, or other device with BT/BLE functionality) via wireless communication channels 180. Wireless communications 182 are received by the BT/BLE device 132 and transmitted from the BT/BLE device 102 (and vice versa) via the wireless communication channels 180.

The BLE standard defines a hierarchy of layers and components to be implemented by each electronic device to support low-power wireless communications. The bottom layer defined by the BLE standard is the BLE controller 120, 150, which includes the physical (PHY) layer and a radio frequency (RF) layer 126, 156. The RF layer may include a transducer, such as a transceiver, to send and receive RF signals under control of the controller 120, 150. Above the BLE controller is the BLE host 108, 138. Above the BLE host layer 108, 138 resides the application layer 104, 134 with applications 106, 136 configured to send or receive data via the BLE host layer and BLE controller layer. In BLE, communication channels include data channels and advertisement channels. In some embodiments, the devices 102, 132 communicate using data channels. In BLE, each data channel has a unique band between 2.4 GHz and 2.4835 GHz, and each of those channels has unique frequency-dependent characteristics.

In the example of FIG. 1, the BT/BLE device 102 includes a BT/BLE stack 103 with an application layer 104, a host layer 108, and a controller layer 120. The application layer 104 includes one or more applications 106 executed by the BT/BLE device 102. The host layer 108 includes a generic access profile (GAP) 110, a generic attribute profile (GATT) 112, an attribute protocol (ATT) 114, a security manager (SM) 116, and a logic link control and adaptation protocol (L2CAP) 118. The controller layer 120 includes a link layer (LL) 124 and PHY/RF layers 126. In some example embodiments, the BT/BLE device 102 uses dedicated signaling (e.g., API signaling) referred to as host controller interface (HCI) 122 to communicate between the host layer 108 and the controller layer 120.

The BT/BLE device 132 includes a BT/BLE stack 133 with an application layer 134, a host layer 138, and a controller layer 150. The application layer 134 includes one or more applications 136 executed by the RX BT/BLE device 130. The host layer 138 includes GAP 140, GATT 142, ATT 144, SM 146, and L2CAP 148. The controller layer 120 includes LL 154 and PHY/RF layers 156. In some example embodiments, the RX BT/BLE device 130 uses dedicated signaling (e.g., API signaling) referred to as HCI 152 to communicate between the host layer 138 and the controller layer 150. In some example embodiments, the application layer 134 and/or the host layer 138 are in communication with a host/application entity 160.

Various implementations described herein may be symmetrical with respect to a peripheral device and a central device. For instance, in a BLE scenario, such as which is illustrated in FIG. 1, the central device and peripheral device may play distinct roles in facilitating efficient and low-power data exchange. For example, the central device typically assumes the role of overseeing and managing the communication process. In some examples, the central device initiates connections, controls data transmission intervals, and coordinates communication with one or more peripheral devices. In some examples, peripheral devices respond to the requests from the central device and transmit data as needed. Peripheral devices may be designed to be power-efficient, often operating in a sleep mode and waking up only when necessary to conserve energy. This central-peripheral relationship allows for a flexible and energy-efficient network configuration, making BLE technology appropriate for some applications such as wearable devices, smart sensors, and other Internet of Things (IoT) implementations where low power consumption is beneficial.

Furthermore, in various embodiments, a device operating as a scanner may become a central after a connection is established. Similarly, in various embodiments, a device operating as an advertiser may become a peripheral after the connection is established.

In the examples herein, either one of the devices 102, 132 may be a central device or a peripheral device, and either one of the devices 102, 132 may transmit an advertising packet that includes device identifying data, receive an advertising packet that includes device identifying data, analyze device identifying data to determine whether to monitor another channel for an auxiliary packet, and establish a connection if appropriate.

The device identifying functionalities described herein may be performed by software, firmware, or hardware logic. For instance, in some example embodiments, the actions to generate a packet with device identifying data, receive a packet with device identifying data, read the device identifying data and take an appropriate action in response thereto, and/or the like may be performed by a processing device (e.g., either of controllers 120, 150) executing computer-readable code to implement a link layer 124, 154. Furthermore, in some examples, the actions to generate a packet with device identifying data, receive a packet with device identifying data, read the device identifying data and take an appropriate action in response thereto, and/or the like may be performed by a processing device (e.g., either of controllers 120, 150) executing computer-readable code to implement a link layer 124, 154.

In some embodiments, controller 120 may be implemented with a generic or custom processor or controller, e.g., capable of executing instructions stored in an associated memory. In some embodiments, controller 120 may be implemented in hardware using state machines. Other implementations are also possible.

In some embodiments, controller 150 may be implemented with a generic or custom processor or controller, e.g., capable of executing instructions stored in an associated memory. In some embodiments, controller 150 may be implemented in hardware using state machines. Other implementations are also possible.

In some embodiments, host 108 may be implemented with a generic or custom processor or controller, e.g., capable of executing instructions stored in an associated memory. In some embodiments, host 108 may be implemented in hardware using state machines. Other implementations are also possible.

In some embodiments, host 138 may be implemented with a generic or custom processor or controller, e.g., capable of executing instructions stored in an associated memory. In some embodiments, host 108 may be implemented in hardware using state machines. Other implementations are also possible.

In some embodiments, host 108 and controller 120 may be combined and may be implemented using, e.g., a single, e.g., generic or custom processor or controller, e.g., capable of executing instructions stored in an associated memory.

In some embodiments, host 138 and controller 150 may be combined and may be implemented using, e.g., a single, e.g., generic or custom processor or controller, e.g., capable of executing instructions stored in an associated memory.

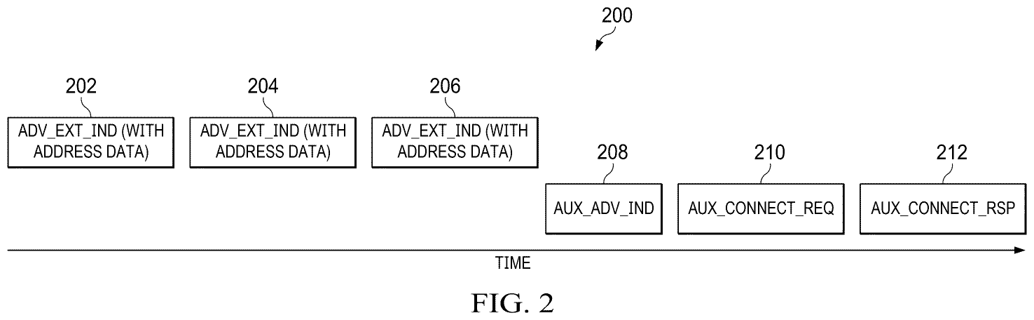

FIG. 2 is an illustration of an example time domain operation 200, according to various embodiments. The flow of time is shown as going from left to right, and specific timings, interframe spacing, and the like are omitted for ease of illustration. Nevertheless, it is understood that various embodiments may include specific spacing and other timing features as appropriate.

In the time domain operation 200, device 132 may function as an advertiser, and device 102 may function as a scanner (or vice versa). Time domain operation 200 includes extended advertising packets 202, 204, 206 (represented by their respective PDUs). For instance, in BLE, an advertising device may transmit extended advertising packet 202 on a first advertising channel (e.g., channel 37), transmit extended advertising packet 204 on a second advertising channel (e.g., channel 38), and transmit extended advertising packet 206 on a third advertising channel (e.g., channel 37), where packets 202, 204, and 206 may be identical. This may be referred to as an advertising event, and the advertising device may repeat the advertising multiple times according to an advertising interval.

In some embodiments, the extended advertising packets 202, 204, 206 may be transmitted by an advertising device on primary advertising channels. The extended advertising packets 202, 204, 206 may include a pointer (not shown) that identifies a channel and a timing for the auxiliary packet 208 (represented by its PDU). The auxiliary packet 208 may be transmitted by the advertising device on a data channel (e.g., channel 0). In some embodiments, the data channel used for auxiliary packet 208 may be referred to as a secondary advertising channel.

A scanning device may listen on the advertising channels according to a scanning interval. For instance, the scanning device may listen to all three primary advertising channels or less than all three advertising channels. In any event, the scanning device may eventually receive and decode one or more of the extended advertising packets 202, 204, 206. In one example, the scanning device may receive, decode, and parse the data in extended advertising packet 206.

In this example, each of the extended advertising packets 202, 204, 206 includes address data to identify the advertising device. In one example, such device identifying data may include a BD address, though the scope of implementations is not limited to any particular addressing scheme. In an example in which device 132 functions as an advertiser, the address data may correspond to a BD address of device 132; in an example in which device 102 functions as an advertiser, the address data may correspond to a BD address of device 102.

Continuing with the example, the scanning device may parse the data in extended advertising packet 206 to retrieve the address data. The scanning device may compare the address data with stored address data corresponding to a desired advertising device. The scanning device may then determine whether to monitor a data channel, on which packet 208 is transmitted, based on whether the address data corresponds to the desired advertiser.

Assuming that the address data included in extended advertising packet 206 corresponds to a desired advertising device, then the scanning device may then listen on a data channel according to a pointer in extended advertising packet 206. The scanning device, as it listens on the data channel, may then receive and decode auxiliary packet 208. In response, the scanning device may transmit connection request packet 210 (represented by its PDU) to the advertising device. Assuming that the advertising device is configured to connect with the particular scanning device, the advertising device may then accept the connection request by transmitting connection response packet 212 (represented by its PDU). The scanning device and advertising device may then negotiate connection parameters, establish the connection, and exchange data as appropriate.

However, assuming that the address data included in extended advertising packet 206 does not correspond to a desired advertising device, then the scanning device may simply ignore packet 206. Ignoring packet 206 may include not taking further action based on the packet 206, including not following the pointer to monitor the data channel for packet 208 and not sending a connection request packet 210. Instead, the scanning device may instead continue to monitor the primary advertising channels for subsequent extended advertising packets. Some of those extended advertising packets may be transmitted by the same advertising device, by a different advertising device, or even by the desired advertising device. The scanning device may be configured to take appropriate action for subsequent packets based on address data within those subsequent packets.

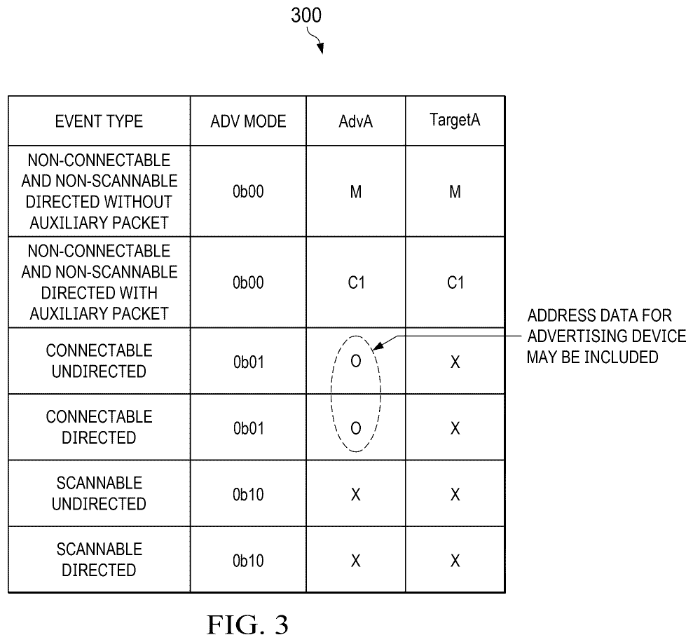

FIG. 3 is an illustration of an example table 300, according to various embodiments, for an extended advertising scheme. Table 300 includes columns that correspond to event type, advertising mode, advertising address (AdvA), and target address TargetA).

The event type column identifies different allowed advertising events. For instance, the top row refers to a non-connectable and non-scannable directed event without an auxiliary packet. The row below corresponds to a non-connectable and non-scannable directed event with an auxiliary packet. The bottom two rows correspond to a scannable and undirected event and a scannable directed event. Two rows in the middle refer to connectable advertising events. The data in the rows may use X for not allowed, M for mandatory, and C1 for optional or reserved.

As noted above, some of the advertising events are connectable and some are not connectable. According to one implementation, the connectable undirected event and the connectable directed event may be defined so that an address of the advertising device (AdvA) is optional, as noted by the “O” symbols. For instance, the extended advertising packets 202, 204, 206 of FIG. 2 may include AdvA. By contrast, current BLE standards prohibit address data of the advertising device (AdvA) in connectable advertising modes for extended advertising.

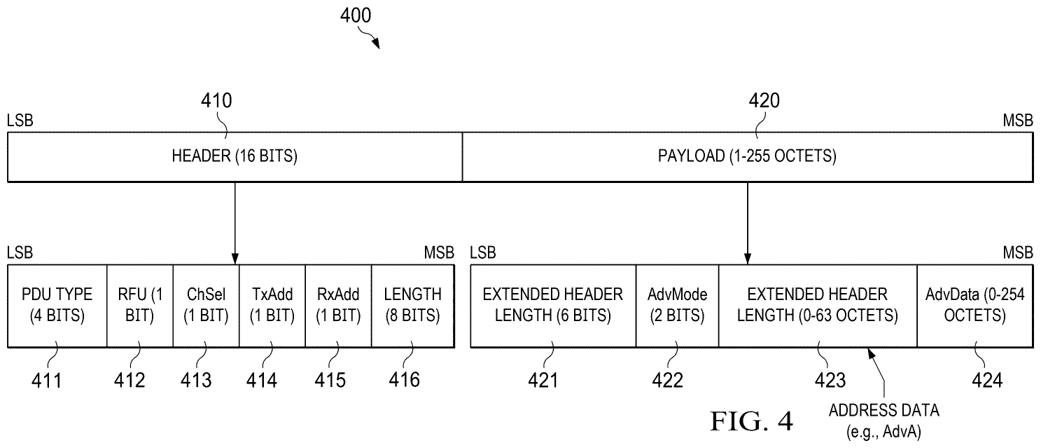

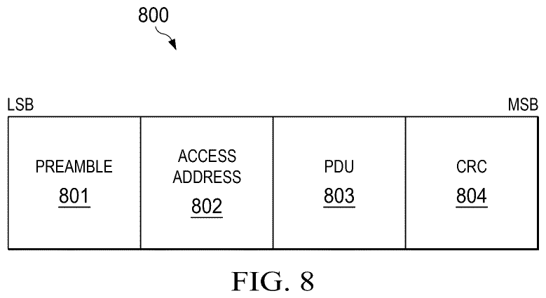

FIG. 4 is an illustration of an example protocol data unit (PDU) 400 of a link layer packet, such as an extended advertising packet, according to various embodiments. For instance, the extended advertising packets 202, 204, 206 (FIG. 2) may include a PDU that conforms to the PDU 400. A BLE packet itself, including a PDU, is described below with respect to FIG. 8.

The PDU 400 includes header 410 and payload 420. The header 410 includes fields 411-416.

Field 411—PDU Type: Identifies the type of PDU (e.g., ADV_EXT_IND, AUX_ADV_IND, etc.).

Field 412—RFU (Reserved for Future Use): Reserved bits for potential future enhancements.

Field 413 ChSel (Channel Selection): Indicates which advertising channels (primary or secondary) the PDU is transmitted on.

Field 414 TxAdd (Transmitter Address Type): Specifies whether the transmitter address is public or random.

Field 415 RxAdd (Receiver Address Type): Indicates whether the receiver address is public or random.

Field 416 Length: Specifies the length of the payload data in octets (2-257 octets).

In an example in which the address data indicates a BD address, the address is public. However, in an example in which the address is a resolvable private address, the address may be random. Field 414 may be set accordingly.

PDU 400 also includes payload 420. The payload 420 includes fields 421-424.

Field 421—Extended Header Length: This field specifies the length of the extended header (field 423) in octets (bytes). The extended header (field 423) provides additional information beyond the standard advertising data. The value of field 421 may depend on the specific use case and the type of extended advertising PDU being used.

Field 422—AdvMode (Advertising Mode): Indicates the type of advertising being performed. Possible values may include Connectable undirected advertising, Connectable directed advertising, Scannable undirected advertising, Non-connectable undirected advertising.

Field 423—Extended Header: The extended header contains additional information specific to the advertising mode. For example, in connectable directed advertising, the extended header may include the target address to which the advertising packet is directed. The structure and content of the extended header field 423 may vary based on the advertising mode and PDU type.

Field 424—AdvData (Advertising Data): The actual payload of the advertising packet. It may include information that the advertising device wants to transmit to other devices. Field 424 may include data such as device name, service UUIDs, manufacturer-specific data, and other relevant information. The length of the AdvData field may vary (up to 31 bytes on the primary channels) and may depend on the specific use case and data being advertised.

In one example use case, the link layer of the advertising device may generate a packet that includes a PDU that conforms to the example of PDU 400. The link layer may populate field 411 to indicate an extended advertising PDU type, such as ADV_EXT_IND. The link layer may also populate the field 423 to include address data, such as a BD address or a resolvable private address. In one example, the address data may include six additional bytes, so the link layer may also set a value in field 421 to indicate an appropriate length of field 423. A link layer of an example scanner may receive and decode the packet, including the PDU 400, parse the data in the various fields, access the address data, and decide whether to monitor for a corresponding auxiliary packet based upon the address data.

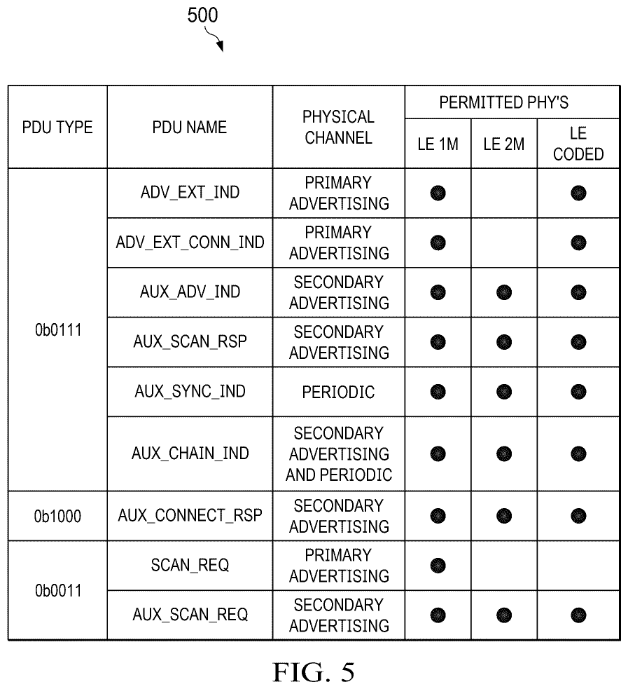

FIG. 5 is an illustration of an example Table 500 of PDU types, according to various embodiments. In an example implementation, a PDU type different from ADV_EXT_IND may be used. For instance, a connectable extended advertising PDU, which is referred to as ADV_EXT_CONN_IND in this example, may be used. The PDU may be defined to include the advertiser's address, such as a BD address or a resolvable private address. Furthermore, the PDU ADV_EXT_CONN_IND may correspond to the format of the example PDU 400 of FIG. 4.

When generating packets having an ADV_EXT_CONN_IND PDU, the link layer of the advertising device may populate field 411 to indicate a PDU type corresponding to ADV_EXT_CONN_IND. In the example of FIG. 5, the PDU type of ADV_EXT_CONN_IND is the same PDU type as ADV_EXT_IND (0b0111). However, in other implementations, the PDU type of those two PDUs may be defined to be different. Note that both ADV_EXT_CONN_IND and ADV_EXT_IND PDU types may be used with a 1 M PHY or a coded PHY, according to Table 500.

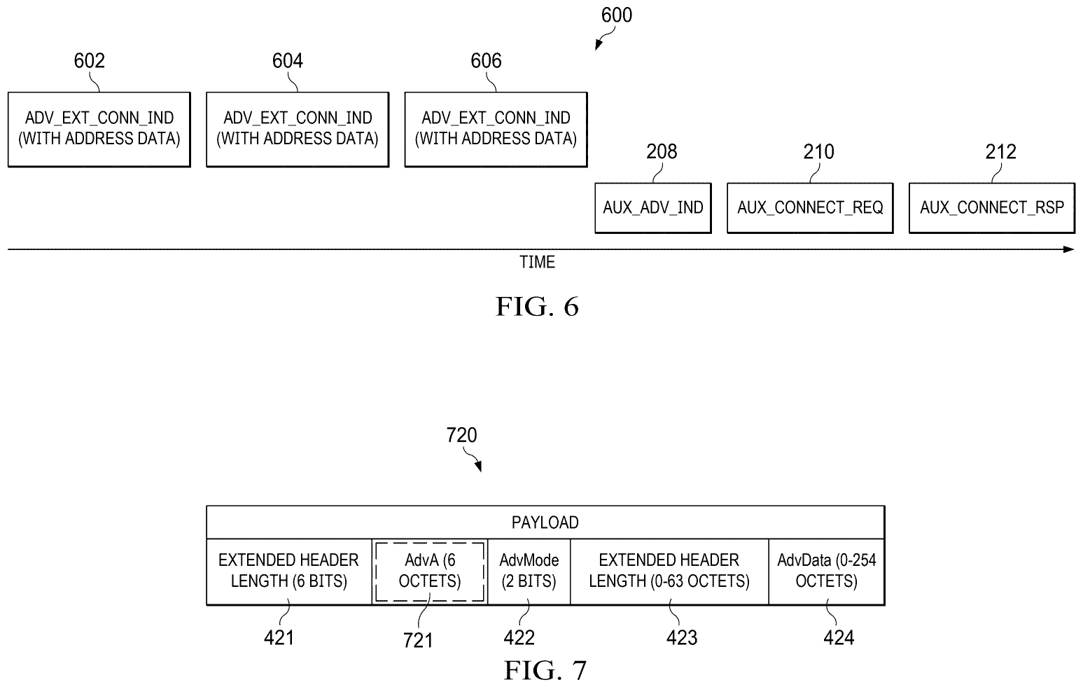

FIG. 6 is an illustration of an example time domain operation 600, according to various embodiments. The flow of time is shown as going from left to right, and specific timings, interframe spacing, and the like are omitted for ease of illustration. Nevertheless, it is understood that various embodiments may include specific spacing and other timing features as appropriate. Also, the packets 602-606 are illustrated by their respective PDUs.

Time domain operation 600 is similar to time domain operation 200 of FIG. 2. A difference between the embodiment of FIG. 6 in the embodiment of FIG. 2 is that the embodiment of FIG. 6 uses the PDU ADV_EXT_CONN_IND instead of ADV_EXT_IND. In this example, the PDU ADV_EXT_CONN_IND includes address data. The PDU ADV_EXT_CONN_IND may include the address data in any appropriate place, such as in an extended header (e.g., field 423 of FIG. 4) or as its own field in payload 420. As noted above, an example of address data may include a BD address, a resolvable private address, or the like.

As with the example of FIG. 2, the extended advertising packets 602, 604, 606 may be transmitted on primary advertising channels and may include pointers to the auxiliary packet 208. A scanning device may scan the primary advertising channels, decode and parse one of the extended advertising packets 602, 604, 606, access the address data, and determine whether to monitor for the auxiliary packet 208 based upon the address data.

In another implementation, the example PDU 400 of FIG. 4 may be modified to include a payload 720 (FIG. 7), rather than payload 420. For instance, payload 720 may include fields 421-424 as well as field 721. Field 721 may be configured to carry address data of an advertising device, such as a BD address or a resolvable private address. In one example, the PDU ADV_EXT_IND may be modified to include the payload 720. Thus, in contrast to the example above in which address data may be included in extended header field 423, the address data may instead be included in field 721.

In this example, field 721 is placed between the extended header length field 421 and the advertising mode field 422. However, the scope of embodiments may include any particular arrangement of fields, including placing field 721 at either the leading edge or the trailing edge of payload 720, or interleaved within the various fields 421-424.

An advertising device may generate an extended advertising packet, including a PDU that has payload 720. The advertising device may set a value in field 411 to indicate a connectable extended advertising PDU type. The advertising device may transmit the extended advertising packet on the primary advertising channels. A scanning device may receive the extended advertising packet and decode and parse the data in the various fields. The scanning device may access the data in field 721 and then determine whether to monitor for a corresponding auxiliary packet in response to the data in field 721.

Furthermore, the PDU ADV_EXT_CONN_IND of FIG. 6 may include the advertising data in its own payload field, such as an example field 721 of FIG. 7.

The examples above refer to extended advertising, which may include advertising packets on primary advertising channels, where those advertising packets point to auxiliary packets that are on a channel other than the primary advertising channels. As noted above, connectable extended advertising packets do not currently support address data for an advertising device. Some legacy advertising (e.g., as with PDU ADV_IND) may include address data for an advertising device. However, some legacy advertising may not support coded PHY, instead being limited to 1 M PHY. Applications in which advertising data may be received incorrectly, such as in crowded advertising scenarios or longer distance reception, may benefit from coded PHY over 1 M PHY. Therefore, in another implementation, legacy advertising (e.g., as with PDU ADV_IND) may include address data for an advertising device as well as error correction code (ECC) bits to support coded PHY. In such an example, a link layer of an advertising device generate and transmit such packets, and a link layer of a scanning device may receive and decode such packets. As with the examples above, the scanning device may access the address data and then determine whether to move forward with actions that may lead to establishing a connection with the advertising device based upon whether the address data corresponds to a desired advertising device.

FIG. 8 is an illustration of an example packet 800, according to various embodiments. Example packet 800 conforms to a BLE standard, though the scope of implementations may include any appropriate protocol, whether proprietary or standard. A packet, such as example packet 800 may be generated and transmitted by a link layer of a device (e.g., device 102 or 132 of FIG. 1) configured to function as an advertiser and received by a device configured to function as a scanner (e.g., the other of device 102 or 132).

Packet 800 includes a preamble 801. The preamble serves as an initial part of the packet 800 and may be used as a synchronization signal. The Access Address field 802 uniquely identifies a BLE connection. The PDU field 803 may include a PDU, such as the PDUs described above. For instance, the PDU field 803 may include a PDU that conforms to PDU 400 of FIG. 4 and may include a header, such as header 410 and a payload 420 or 720. In the present examples, the PDU field 803 may include a PDU of a PDU type that is an extended advertising PDU and is connectable. Furthermore, the PDU of PDU field 803 may carry device address information of the advertiser, as described above with respect to the examples of FIGS. 2-7.

CRC field 804 may include a hash used for error detection and correction. For instance, the link layer may generate an ECC hash based on fields 801-803 and append that hash as field 804. A scanning device may receive and decode the packet 800 and then detect and correct (if appropriate) the contents of the packet 800.

Furthermore, various embodiments may include any appropriate packet format, with example packet 800 being one example. In fact, the scope of implementations may include other protocols which may use other and different packet formats. The principles discussed herein, such as including advertising device address data in an advertising packet, may be applied to those other protocols and other packet formats.

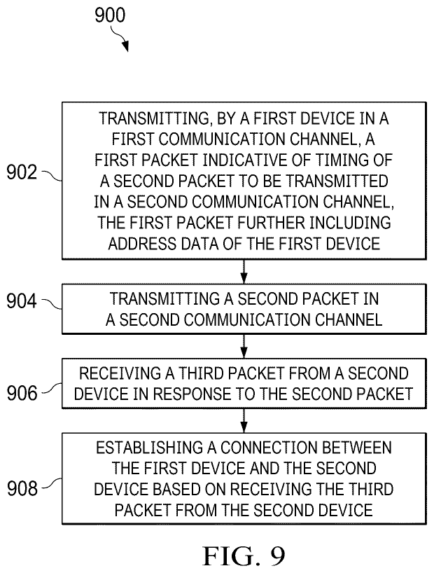

FIG. 9 is an illustration of an example method 900, for providing advertising device address data in an extended advertising packet, according to various embodiments. Example method 900 may be performed by a processor, such as implemented on a semiconductor die, as the processor executes computer-executable code that it reads from non-transitory computer-readable media. More specifically, method 900 may be performed by a device functioning as an advertiser. Examples of devices that may perform example method 900 include devices 102 (e.g., using 108 or 120), and 132 (e.g., using 138 or 150) of FIG. 1, which include respective link layers 124, 154, the link layers being responsible for packet generation and packet reception.

At action 902, the advertising device (a first device) transmits a first packet in a first communication channel. For instance, the first packet may be an advertising packet that includes an extended advertising PDU. The first packet may indicate a timing of a second packet to be transmitted in a second communication channel. For instance, the first packet may indicate a channel and a timing of an auxiliary packet on a data channel. Furthermore, the first packet may be transmitted as part of a connectable advertising event.

In the examples of FIGS. 2 and 6, the extended advertising packets include PDUs ADV_EXT_IND (FIG. 2) and ADV_EXT_CONN_IND (FIG. 6), both of which include pointers to auxiliary packet 208. The PDUs of the advertising packets may also include an address of the advertising device, such as in the examples above at FIGS. 2-7.

At action 904, the advertising device transmits a second packet in a second communication channel. As noted above, an example may include transmitting an auxiliary packet (e.g., packet 208) in a channel that is different from a primary advertising channel. In one example, the second channel may be a channel that is used for data transmission during a connection. In this example, the first packet is of a first type (e.g., an extended advertising packet), and a second packet is of a second type (e.g., an auxiliary packet).

At action 906, the advertising device may receive a third packet from a second device in response to the second packet. For instance, the second device may include a scanning device, and the scanning device may have received and decoded the first packet and the second packet. The scanning device may transmit a connection request packet (e.g., packet 210) in response to the auxiliary packet and for the purpose of establishing a connection with the advertising device. In this example, the connection request packet illustrates a third packet type.

At action 908, the advertising device establishes a connection based on receiving the third packet from the second device. For instance, the advertising device may transmit a connection response packet, such as packet 212, to the scanning device. The scanning device and the advertising device may then negotiate parameters for the connection and establish the connection. Once the connection is established, the scanner may be a central device, and the advertiser may be a peripheral device. The connection may include exchanging data between the devices for as long as the connection remains.

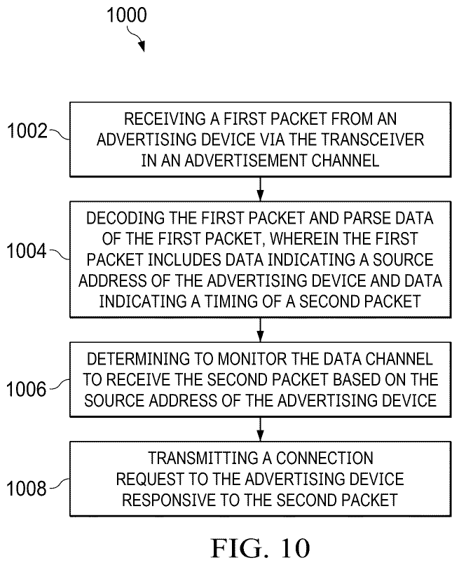

FIG. 10 is an illustration of an example method 1000, for receiving and acting upon an extended advertising packet having advertising device address data, according to various embodiments. Example method 1000 may be performed by a processor, such as implemented on a semiconductor die, as the processor executes computer-executable code that it reads from non-transitory computer-readable media. More specifically, method 1000 may be performed by a device functioning as a scanner. Examples of devices that may perform example method 1000 include devices 102 (e.g., using 108 or 120), and 132 (e.g., using 138 or 150) of FIG. 1, which include respective link layers 124, 154, the link layers being responsible for packet generation and packet reception.

At action 1002, the scanning device receives a first packet, via its transceiver, from an advertising device and in an advertisement channel. For instance, the advertisement channel may be a primary advertisement channel.

In the examples above, a scanning device may monitor primary advertising channels and may receive one or more of the extended advertising packets 202, 204, 206 (FIG. 2) or 602, 604, 606 (FIG. 6). The extended advertising packets may include a PDU indicating a connectable event, where examples of the PDUs may include ADV_EXT_IND and ADV_EXT_CONN_IND.

At action 1004, the link layer of the scanning device may decode the first packet and parse data of the first packet. For instance, the scanning device may parse the data to access data indicating a source address of the advertising device. An example of data indicating a source address of the advertising device may include a BD address, a resolvable private address, or other appropriate address of an advertising device. Furthermore, the first packet may include data indicating a timing of a second packet. For instance, the first packet may include a pointer to a channel and a timing of an auxiliary packet.

At action 1006, the scanning device may determine to monitor the data channel to receive the second packet. For instance, the scanning device at action 1004 may have access to the address data of the advertising device. Then at action 1006, the scanning device may compare the address data of the advertising device to stored address data that indicates a desired device. Action 1006 may include determining whether the address data of the advertising device matches address data of a desired device. At action 1006, the scanning device has determined that the address data of the advertising device matches address data of a desired device and has further determined, based upon that match, to monitor the data channel at which the second packet is transmitted. An example of a second packet may include an auxiliary packet, such as packet 208 of FIGS. 2 and 6.

At action 1008, the scanning device transmits a connection request to the advertising device responsive to the second packet. For instance, the scanning device may transmit a connection request (e.g., as in packet 210 of FIGS. 2 and 6) to the advertising device.

Although not shown explicitly in FIG. 10, the advertising device and the scanning device may move forward with establishing a connection. In one example, the advertising device may transmit a connection response (e.g., as in packet 212 of FIGS. 2 and 6), and the devices may negotiate connection parameters. Once the connection is established, the advertising device may be a peripheral device, and the scanning device may be a central device.

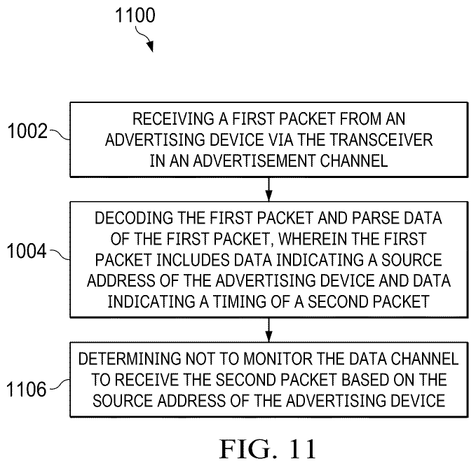

FIG. 11 is an illustration of an example method 1100, for receiving and acting upon an extended advertising packet having advertising device address data, according to various embodiments. Example method 1100 may be performed by a processor, such as implemented on a semiconductor die, as the processor executes computer-executable code that it reads from non-transitory computer-readable media. More specifically, method 1100 may be performed by a device functioning as a scanner. Examples of devices that may perform example method 1000 include devices 102 (e.g., using 108 or 120), and 132 (e.g., using 138 or 150) of FIG. 1, which include respective link layers 124, 154, the link layers being responsible for packet generation and packet reception.

Actions 1002 and 1004 may be the performed same as actions 1002 and 1004 of FIG. 10. However, in the example of method 1100, the data indicating the source address of the advertising device does not correspond to an address of a desired device. For instance, as noted above, the scanning device may store address data for one or more desired devices. The scanning device may also be configured to compare received advertising device address data to the stored address data to determine whether a received extended advertising packet is from a desired device. In the example of method 1000, the scanning device compares the received address data and, from that comparison, determines that the advertising device corresponds to a desired device. By contrast, in the example of method 1100, the scanning device compares the received address data, and from that comparison determines that the advertising device does not correspond to a desired device.

At action 1106, the scanning device determines not to monitor the data channel to receive the second packet. For instance, the address data, which is the source address of the advertising device, is determined by the scanning device to not match an address of a desired device. The scanning device, in response to the comparison, then determines not to take further action with respect to the first packet. In this example, taking no further action may include not monitoring the data channel to receive a corresponding auxiliary packet. Further in this example, taking no action may include deleting the packet and not moving forward with actions that might lead to a connection with the advertising device.

Although not shown explicitly at action 1106, the scanning device may further continue to monitor primary advertising channels to receive other extended advertising packets. The scanning device may receive and decode other extended advertising packets, access source address for advertising devices of those packets, and then take action based on the source address for the advertising devices.

Various embodiments may include advantages over other solutions. For instance, various embodiments may include an advertising device placing its own address information in a transmitted extended advertising packet. The address of the advertising device may allow a scanning device to compare the address to a stored address of a desired device and, based thereon, to determine whether or not to monitor another channel for a corresponding auxiliary packet. The scanning device may save power and time by avoiding monitoring for an auxiliary packet when the scanning device determines that the advertising device address does not correspond to an address of a desired device. Furthermore, various embodiments herein may be implemented without adding substantial overhead, as address data may be relatively small compared to a size of a packet. Moreover, various embodiments may find use with a coded PHY, thereby allowing for use in scenarios in which some bits in a received packet may be corrupted.

Example embodiments of the present disclosure are summarized here. Other embodiments can also be understood from the entirety of the specification and the claims filed herein.

Example 1. A method including: transmitting, by a first device in a first communication channel, a first packet indicative of timing of a second packet to be transmitted in a second communication channel, the first packet including a first address associated with the first device, where the first packet is of a first type, and where the second packet is of a second type, where the first packet has a protocol data unit (PDU) field including a header and a payload, where the payload includes data indicative of the timing of the second packet and of the second communication channel and further includes the first address, and further where the payload includes an Extended Header Length field indicating a length of an Extended Header field, where the payload includes an address field between the Extended Header Length field and the Extended Header field, and where the address field includes the first address; and establishing a connection between the first device and a second device based on receiving, by the first device, a third packet from the second device, where the third packet is responsive to the second packet.

Example 2. The method of example 1, where the third packet is of a third type.

Example 3. The method of one of examples 1 or 2, further including transmitting, by the first device in a third communication channel, a fourth packet indicative of the timing of the second packet.

Example 4. The method of one of examples 1 to 3, where transmitting the fourth packet includes transmitting the fourth packet after transmitting the first packet.

Example 5. The method of one of examples 1 to 4, where transmitting the fourth packet includes transmitting the fourth packet before transmitting the first packet.

Example 6. The method of one of examples 1 to 5, where the first communication channel is an advertisement channel, and where the second communication channel is a data channel.

Example 7. The method of one of examples 1 to 6, where the first packet is one of a plurality of identical packets transmitted on respective advertisement channels of a plurality of advertisement channels, where the first communication channel is one of the plurality of advertisement channels.

Example 8. The method of one of examples 1 to 7, where the second communication channel is different from any of the plurality of advertising channels.

Example 9. The method of one of examples 1 to 8, where the first type is an advertising packet type.

Example 10. The method of one of examples 1 to 9, where the second type is an auxiliary packet type.

Example 11. The method of one of examples 1 to 10, where the second type is larger in bytes than the first type.

Example 12. The method of one of examples 1 to 11, where the first packet includes a connectable undirected packet.

Example 13. The method of one of examples 1 to 12, where the first packet includes a connectable directed packet.

Example 14. The method of one of examples 1 to 13, where transmitting the first packet includes transmitting the first packet over the air using a coded physical layer (PHY).

Example 15. The method of one of examples 1 to 14, where the first packet includes a cyclic redundancy check (CRC) field.

Example 16. The method of one of examples 1 to 15, where the header identifies the first packet as an advertising PDU type.

Example 17. The method of one of examples 1 to 16, where the header identifies the first packet as an advertising PDU type that is ADV_EXT_IND.

Example 18. The method of one of examples 1 to 17, where the first address includes six bytes of a Bluetooth Device (BD) address in the payload.

Example 19. An electronic device including: a transceiver; and a processor configured to: receive a first packet from an advertising device via the transceiver in an advertisement channel; decode the first packet and parse data of the first packet, where the first packet includes an advertising packet for connection, where the first packet includes first data indicating a data channel for a second packet and timing of the second packet, and second data indicating a source address of the advertising device; parse, within a protocol data unit (PDU) field of the first packet, a header and a payload, where the payload includes the first data and the second data; parse, from the payload, an Extended Header Length field indicating a length of an Extended Header field, further where the payload includes an address field between the Extended Header Length field and the Extended Header field, where the address field includes the second data; and determine whether to monitor the data channel to receive the second packet in response to parsing the second data.

Example 20. The electronic device of example 19, where the processor is configured to transmit a connection request to the advertising device responsive to the second packet.

Example 21. The electronic device of one of examples 19 or 20, where the electronic device is a sensor device.

Example 22. The electronic device of one of examples 19 to 21, where the electronic device is a smartphone.

Example 23. The electronic device of one of examples 19 to 22, where the processor is configured to:

Example 24. The electronic device of one of examples 19 to 23, where the processor is configured to: identify, from the header, the first packet as an advertising PDU type.

Example 25. The electronic device of one of examples 19 to 24, where the processor is configured to: identify, from the header, the first packet as an advertising PDU type that is ADV_EXT_IND.

Example 26. The electronic device of one of examples 19 to 25, where the processor is configured to: parse the address information of the advertising device, which includes six bytes of Bluetooth Device (BD) address information in the payload.

Example 27. An electronic device including: a transceiver; and a processor configured to: receive a first packet over the air via the transceiver from an advertising device; decode the first packet and parse data of the first packet, where the first packet includes an advertising packet for connection, where the first packet includes data indicating a data channel location of a second packet and a time of the second packet and data indicating a source address of the advertising device; parse, within the first packet, a header and a payload, where the payload includes the data indicating the data channel location and the data indicating the source address of the advertising device; parse, from the payload: an Extended Header field, an Extended Header Length field indicating a length of the Extended Header field, and an address field having the address information of the advertising device; and determine not to receive the second data packet based on the source address.

Example 28. An electronic device including: a transceiver; and a processor configured to: receive a first packet over the air via the transceiver from an advertising device; decode the first packet and parse data of the first packet, where the first packet includes an advertising packet for connection, where the first packet includes data indicating a data channel location of a second packet and a time of the second packet and data indicating a source address of the advertising device; parse, within the first packet, a header and a payload, where the payload includes the data indicating the data channel location and the data indicating the source address of the advertising device; parse, from the payload: an Extended Header field, an Extended Header Length field indicating a length of the Extended Header field, and an address field having the address information of the advertising device; and not monitoring the data channel during the time of the second packet based on the source address.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims.

What is claimed is:

1. A method comprising:
transmitting, by a first device in a first communication channel, a first packet indicative of timing of a second packet to be transmitted in a second communication channel, the first packet including a first address associated with the first device, wherein the first packet is of a first type, and wherein the second packet is of a second type, wherein the first packet has a protocol data unit (PDU) field including a header and a payload, wherein the payload includes data indicative of the timing of the second packet and of the second communication channel and further includes the first address, and further wherein the payload includes an Extended Header Length field indicating a length of an Extended Header field, wherein the payload includes an address field between the Extended Header Length field and the Extended Header field, and wherein the address field includes the first address; and
establishing a connection between the first device and a second device based on receiving, by the first device, a third packet from the second device, wherein the third packet is responsive to the second packet.

2. The method of claim 1, wherein the third packet is of a third type.

3. The method of claim 1, further comprising transmitting, by the first device in a third communication channel, a fourth packet indicative of the timing of the second packet.

4. The method of claim 3, wherein transmitting the fourth packet comprises transmitting the fourth packet after transmitting the first packet.

5. The method of claim 3, wherein transmitting the fourth packet comprises transmitting the fourth packet before transmitting the first packet.

6. The method of claim 1, wherein the first communication channel is an advertisement channel, and wherein the second communication channel is a data channel.

7. The method of claim 1, wherein the first packet is one of a plurality of identical packets transmitted on respective advertisement channels of a plurality of advertisement channels, wherein the first communication channel is one of the plurality of advertisement channels.

8. The method of claim 7, wherein the second communication channel is different from any of the plurality of advertising channels.

9. The method of claim 1, wherein the first type is an advertising packet type.

10. The method of claim 9, wherein the second type is an auxiliary packet type.

11. The method of claim 1, wherein the second type is larger in bytes than the first type.

12. The method of claim 1, wherein the first packet comprises a connectable undirected packet.

13. The method of claim 1, wherein the first packet comprises a connectable directed packet.

14. The method of claim 1, wherein transmitting the first packet comprises transmitting the first packet over the air using a coded physical layer (PHY).

15. The method of claim 1, wherein the first packet comprises a cyclic redundancy check (CRC) field.

16. The method of claim 1, wherein the header identifies the first packet as an advertising PDU type.

17. The method of claim 1, wherein the header identifies the first packet as an advertising PDU type that is ADV_EXT_IND.

18. The method of claim 1, wherein the first address comprises six bytes of a Bluetooth Device (BD) address in the payload.

19. An electronic device comprising:
a transceiver; and
a processor configured to:
receive a first packet from an advertising device via the transceiver in an advertisement channel;
decode the first packet and parse data of the first packet, wherein the first packet comprises an advertising packet for connection, wherein the first packet includes first data indicating a data channel for a second packet and timing of the second packet, and second data indicating a source address of the advertising device;
parse, within a protocol data unit (PDU) field of the first packet, a header and a payload, wherein the payload includes the first data and the second data;
parse, from the payload, an Extended Header Length field indicating a length of an Extended Header field, further wherein the payload includes an address field between the Extended Header Length field and the Extended Header field, wherein the address field includes the second data; and
determine whether to monitor the data channel to receive the second packet in response to parsing the second data.

20. The electronic device of claim 19, wherein the processor is configured to transmit a connection request to the advertising device responsive to the second packet.

21. The electronic device of claim 19, wherein the electronic device is a sensor device.

22. The electronic device of claim 19, wherein the electronic device is a smartphone.

23. The electronic device of claim 19, wherein the processor is configured to:
receive the first packet, over the air, via the transceiver and using a coded physical layer (PHY).

24. The electronic device of claim 19, wherein the processor is configured to:
identify, from the header, the first packet as an advertising PDU type.

25. The electronic device of claim 19, wherein the processor is configured to:
identify, from the header, the first packet as an advertising PDU type that is ADV_EXT_IND.

26. The electronic device of claim 19, wherein the processor is configured to:
parse the address information of the advertising device, which comprises six bytes of Bluetooth Device (BD) address information in the payload.

27. An electronic device comprising:
a transceiver; and
a processor configured to:
receive a first packet over the air via the transceiver from an advertising device;
decode the first packet and parse data of the first packet, wherein the first packet comprises an advertising packet for connection, wherein the first packet includes data indicating a data channel location of a second packet and a time of the second packet and data indicating a source address of the advertising device;
parse, within the first packet, a header and a payload, wherein the payload includes the data indicating the data channel location and the data indicating the source address of the advertising device;
parse, from the payload: an Extended Header field, an Extended Header Length field indicating a length of the Extended Header field, and an address field having the address information of the advertising device; and
determine not to receive the second data packet based on the source address.

28. An electronic device comprising:
a transceiver; and
a processor configured to:
receive a first packet over the air via the transceiver from an advertising device;
decode the first packet and parse data of the first packet, wherein the first packet comprises an advertising packet for connection, wherein the first packet includes data indicating a data channel location of a second packet and a time of the second packet and data indicating a source address of the advertising device;
parse, within the first packet, a header and a payload, wherein the payload includes the data indicating the data channel location and the data indicating the source address of the advertising device;
parse, from the payload: an Extended Header field, an Extended Header Length field indicating a length of the Extended Header field, and an address field having the address information of the advertising device; and
not monitoring the data channel during the time of the second packet based on the source address.
